(19) United States
(12) Patent Application Publication
(10) Pub. No.: US 2010/0318230 A1
(43) Pub. Date: Dec. 16, 2010

(54) Kitchens exhaust hood and make-up air handling unit optimal speed control system

(76) Inventor: Guopeng Liu, Plymouth Meeting, PA (US)

Correspondence Address: Guopeng Liu, 2098 Butler Pike, Apt. #W7, Plymouth, PA, 19462, US

(21) Appl. No.: 12/484,554

(22) Filed: Jun. 15, 2009

(51) Int. Cl. G05D 7/00; F24C 15/20

(52) U.S. Cl. 700/282; 126/299 D

(57) ABSTRACT

Disclosed is a kitchen exhaust hood and makeup unit control system comprising a control device for controlling the variable speed drive (VSD) for the associated fan, and measurement devices comprising Volatile Organic Compound (VOC) gas transmitter devices and temperature transmitters devices. The exhaust fan VSD speed is controlled to maintain the kitchen hood area at certain comfort level (indoor air quality and thermal comfort) by monitoring the VOC concentration and exhaust duct temperature. The air quality sensors measure the concentration of multiple gases and odorous substances in the air with constant output. These substances, for example, may be cooking smoke, kitchen vapors, human odors and unpleasant smells. The exhaust fan speed is controlled using the proportional-integral-derivative (PID) control loop. The kitchen exhaust and make-up unit supply airflow rate may be measured by an airflow measurement means such as Fan Airflow Station. The kitchen make-up unit fan speed is controlled to maintain the constant airflow difference between the exhaust air and make-up air to maintain the slightly negative pressure in the kitchen area.

### CROSS-REFERENCES TO RELATED APPLICATIONS

U.S. Patent Documents

| | | |
|---|---|---|
| 3,723,746 | March 1973 | Lawson et al. |
| 3,743,430 | July 1973 | Riggs |
| 3,809,480 | May 1974 | Somerville et al. |
| 3,932,137 | January 1976 | Culpepper, Jr. |
| 4,781,460 | November 1988 | Bott |
| 4,903,685 | February 1990 | Melink |
| 4,980,571 | December 1990 | McRae et al. |
| 5,074,281 | December 1991 | Fluhrer et al. |
| 5,146,284 | September 1992 | Tabarelli et al. |
| 5,693,949 | December 1997 | Paris |
| 5,882,254 | March 1999 | Jacob |
| 6,037,580 | March 2000 | Renk |
| 6,078,040 | June 2000 | Endo et al. |
| 6,170,480 | January 2001 | Melink et al. |
| 6,198,110 | March 2001 | Kaye et al. |
| 6,583,726 | June 2003 | Johnson et al. |
| 6,822,216 | November 2004 | Lang et al. |
| 2004/0090627 | May 2004 | Hinderling |
| 2006/0032492 | February 2006 | Bagwell et al. |
| 7,048,199 | Jan. 20, 2004 | Melink et al. |
| 7,442,119 | Apr. 18, 2007 | Fluhrer; Henry |

### Foreign Patent Documents

| | | |
|---|---|---|
| 4,418,409 | August, 1995 | DE |
| 19/509,612 | March, 1996 | DE |
| 200 21 349 | April, 2001 | DE |
| 201 21 682 | March, 2003 | DE |
| 0603538 | June, 1994 | EP |
| 0 788 082 | October, 2002 | EP |
| 06/281,219 | October, 1994 | JP |

### BACKGROUND OF THE INVENTION

I. Field of the Invention

The present invention relates to use the Volatile Organic Compound (VOC) gas transmitter, temperature sensor, airflow measurement device to control the kitchen hood exhaust fan and makeup unit fan speed for the commercial or institutional kitchen systems.

II. Discussion of Prior Art

Commercial and institutional kitchens are equipped to prepare food for a large number of people such as restaurants, school, corporate office, hotels, hospitals, retail malls, and correctional facilities. Such kitchens are typically equipped with one or more commercial duty cooking units and/or dish-washer units. On such a scale, the cooking process may generate substantial amounts of cooking heat and airborne cooking by-products such as water vapor, grease particulates, smoke and aerosols, all of which must be exhausted from the kitchen (102) so as not to foul the environment of the dining area (101).

Kitchen ventilation has at least two purposes: (1) to provide a comfortable environment in the kitchen and (2) to enhance the safety of personnel working in the kitchen and of other building occupants.

The centerpiece of almost any kitchen ventilation system is an exhaust hood (110), which is used primarily to remove effluent from kitchens. Effluent includes the gaseous, liquid, and solid contaminants produced by the cooking process. These contaminants must be removed for both comfort and safety. Large exhaust hoods are usually provided over the cooking units, with duct work connecting the hood to a motor driven exhaust fan located outside the facility such as on the roof or on the outside of an external wall. As the fan is rotated by the motor, air within the kitchen environment is drawn into the hood and exhausted to the outside atmosphere. In this way, the effluent, cooking heat and cooking by-products generated by the cooking units follow an air flow path defined between the cooking units and outside through the hood to be exhausted from the kitchen before they escape into other food preparation area and perhaps into the dining area.

Exhaust flow rate requirements to capture, contain, and remove the heat and effluent vary considerably depending on the hood style, the amount of overhang, the distance from the cooking surface to the hood, the presence and size of side panels, and the cooking equipment and product involved. The hot cooking surfaces and product vapors create thermal air currents that are received or captured by the hood and then exhausted. The velocity of these currents depends largely on the surface temperature and tends to vary from 15 fpm over steam equipment to 150 fpm over charcoal broilers. The actual required flow rate is determined by these thermal currents, a safety allowance to absorb crosscurrents and flare-ups, and a safety factor for the style of hood. The exhaust volumetric flow rate requirement is based on the group of equipment under the hood. If there is more than one group, the flow rate is based on the heaviest duty group unless the hood design permits different rates over different sections of the hood.

The kitchen air that is exhausted to remove the cooking effluent must be replaced with air from outside the building to avoid excess negative pressure in the space, which may degrade the exhaust system performance. The standards and model codes require 100% replacement (makeup) air. In many cases, the heating, ventilation and air-conditioning (HVAC) makeup system (111) is the ideal means of providing replacement air because the air is comfort conditioned and enhances the kitchen environment. The make-up unit may include the supply fan (115), filter (116), and DX coil (117).

In the conventional control, the exhaust fan (112) is operated at a fixed speed. The exhaust fan tends to draw air through the hood at a constant or fixed volume rate without considering the amount of heat or cooking by-product actually being generated variably. As a result, the over-exhausting wastes air consumes more fan power than necessary. If the makeup air is conditioned by the building HVAC, the over-exhausting results in excessive energy consumption including heating, cooling and supply fan power consumption.

To reduce the likelihood of over or under-exhausting, systems have been developed which vary the motor speed between a minimum using a variable speed drive (VSD) (114) and a maximum speed in fixed relationship to the exhaust air temperature, as shown in U.S. Pat. Nos. 4,903,685 and 6,170,480, both assigned to the assignee hereof and both of which are incorporated herein by reference in their entireties. While those systems offer substantial improvements to commercial kitchen exhaust systems, further improvements are desired.

In those systems where the fan speed was varied in relation to exhaust temperature, for example, the relationship between that temperature and the fan speed could be seen as a fixed mathematical formula or as a single curve on a graph. More specifically, past efforts involving variation in the fan speed were based on a fixed linear relationship between temperature and fan speed, for example. Thus, in prior systems, the fan speed would vary over a temperature span defined by a fixed minimum and a fixed maximum temperature In such systems, the fan speed is, thus, operated at a minimum rate if the exhaust air temperature is below a predetermined minimum temperature, is operated at a maximum rate when the exhaust temperature exceeds a predetermined maximum, and is otherwise operated at a speed correlated to the temperature. The typical temperature span is not sufficient to provide the most desirable results. This invention also has the aspect of monitoring the exhaust temperature using temperature sensor (121) to determine when to automatically turn the exhaust hood on or off.

Foreign patent DE 195 09 612 C1 discloses exhaust hoods, which are provided with a transmitter and a receiver, the transmitter emitting radiation which is detected by the receiver. The radiation received by the receiver is used for controlling a ventilator of the exhaust hood in that the difference between the emitted radiation and the received radiation component is interpreted as a measure for the quantity of exhaust gases in the exhaust air flow. The power supply to the ventilator is controlled as a function thereof.

Foreign patent EP 443 141 B1 describes an exhaust hood with an ultrasonic transmitter and an ultrasonic sensor system, in which the signal variations recorded by the ultrasonic sensor system are used as a basis for controlling a ventilator stage. One of the disadvantages of this invention is that the ultrasonic sensor system is expensive and therefore use can only be made thereof for high price exhaust hoods.

To reduce the cost of ultra-sonic transmitter, systems have been developed which using laser beam to detect the smoke or vapor, as shown in U.S. Pat. Nos. 7,048,199 and 7,442,119. Said laser module (122) generates a laser beam which is deflected in accordance with the presence of cooking vapors such as steam. The respective deflection influences the signal generated by the receiver device such that the signal allows the control device or control circuit to draw conclusions about the presence of cooking vapors such as steam or movements of air and thus automatically control the drive unit as needed.

The above inventions improve the kitchen exhaust fan control by utilizing the laser beam device.

[1] However, the above invention is still very expensive for the building owners regard to the high cost of transmitter device (laser module) and receiver device. In addition, the laser beam may potentially cause the laser hazard. The human body is vulnerable to the output of certain lasers, and under certain circumstances, exposure can result in damage to the eye and skin. Research relating to injury thresholds of the eye and skin has been carried out in order to understand the biological hazards of laser radiation. It is now widely accepted that the human eye is almost always more vulnerable to injury than human skin according to Occupational Safety & Health Administrations (department of labor).

[2] Secondly, I have also discovered that using the PID loop control has more advantage over the past inventions such as varying the formula or the curve (or by selecting from various formulae or curves) which defines the relationship between fan speed and exhaust temperature. Using PID control can produce more optimal exhausting conditions within the facility based on our real case study results.

[3] Thirdly, there's no airflow measurement methods have been used in all previous inventions. The kitchen are cannot be maintained at the slightly negative pressure condition if the makeup airflow rate is more than the exhaust air flow and the kitchen exhaust fan speed is at minimum or partial speed. The kitchen contaminants can potentially get into other areas.

By virtue of the foregoing, there is thus provided an exhaust system and method which provides for more optimal exhausting of a facility. These and other objects and advantages of the present invention shall be made apparent from the accompanying drawings and the description thereof.

### SUMMARY OF THE INVENTION

The present invention uses the Volatile Organic Compound (VOC) gas transmitter devices and the temperature sensors to detect the kitchen hood usage. This invention reduces the cost significantly compared with the laser device and ultrasonic transmitter. And it eliminates the potential laser hazard for the chef and kitchen staff by providing safer detection method. The sensitivity of the VOC sensor can be adjusted based on the actual applications. It's much easier for installation and maintenance compared with prior inventions. In addition, this device can also detect the bad smell and volatile organic gas in the kitchen, which cannot be detected by the laser or ultrasonic devices.

The exhaust temperature and VOC concentration are controlled by the proportional-integral-derivative (PID) control loop instead of linear control. One PID loop is controlled to maintain the highest hood temperature at set point. Another PID control loop is controlled to maintain the highest hood VOC concentration at the set point. The exhaust fan VSD speed is the higher value of those two PID loops. It is now widely accepted that the PID control methods can provide reliable and optimal control results if control parameters are well-tuned. If there's more than one exhaust hood, the exhaust fan speed can be controlled at the maximum of all PID loops.

In addition, the make-up unit supply fan VSD speed is controlled to track the exhaust airflow using airflow measurement device such as Fan Airflow Station (pending patent application Ser. No. 11/491,767). Both supply and exhaust airflow rate are measured and monitored during the control process.

Additional objects and advantages of this invention will be apparent from the following detailed description of preferred embodiments thereof which proceeds with reference to the accompanying drawings.

### BRIEF DESCRIPTION OF THE DRAWINGS

The accompanying drawings, which are incorporated in and constitute a part of this specification, illustrate embodiments of the invention, and together with the general description of the invention given above, and the detailed description of the embodiments given below, serves to explain the principles of the present invention.

FIG. 1 is a schematic of a restaurant or institutional facility, primarily the kitchen area and cooking units thereof, including a kitchen exhaust system according to principles of the prior arts. Temperature sensors and laser device are illustrated in this figure.

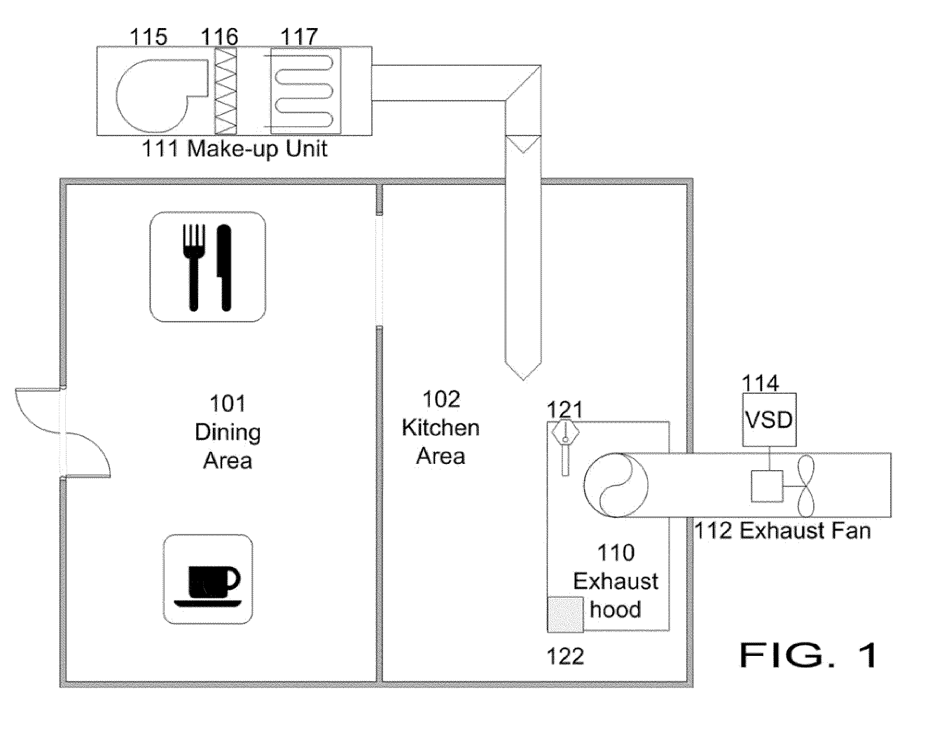

FIG. 2 is a perspective view diagrammatically illustrating a restaurant or institutional facility, primarily the kitchen area and cooking units thereof, including a kitchen exhaust system according to principles of the present invent. An exemplary exhaust system according to principles of the present invention is also illustrated in this figure.

FIG. 3 is a block diagram of an exemplary exhaust system controller according to principles of the present invention.

FIG. 4 is a flowchart of an exemplary control algorithm for exhaust fan implemented by embodiments of the exhaust system of FIG. 2.

FIG. 5 is a flowchart of an exemplary control algorithm for make-up unit supply fan implemented by embodiments of the exhaust system of FIG. 2.

### DETAILED DESCRIPTION

Exemplary Exhaust & Make-Up Control System

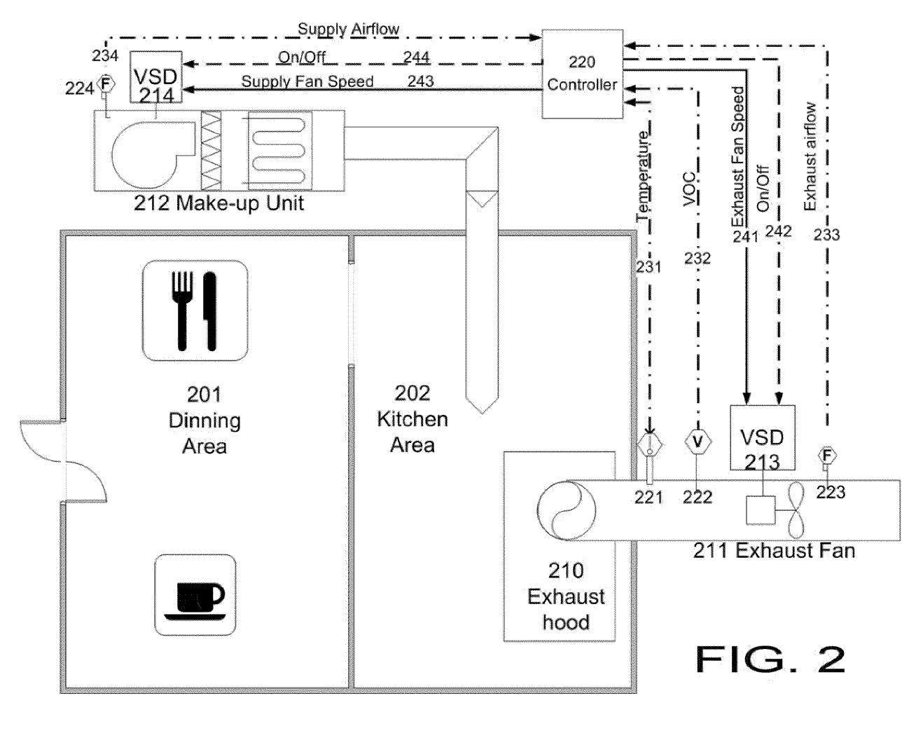

Referring to FIG. 2, a facility such as a restaurant or institutional facility includes a kitchen area (102) and at least one adjacent room such as a dining room (101) with an interior wall separating the two areas. Kitchen includes a plurality of commercial cooking units such as one or more stoves, ovens, griddles and the like. Facility is also equipped with a HVAC system as at which maintains the inside environment at a suitable condition for the use of the occupants of kitchen.

Effluents generated by the cooking process include grease in the solid, liquid, and vapor states; smoke particles; and volatile organic compounds (VOCs or low-carbon aromatics, commonly referred to as odors). Effluent controls in the vast majority of today's kitchen ventilation systems are limited to the removal of solid and liquid grease particles by grease removal devices located in the hood. One of the most common methods of cooking effluent control is to install an air inlet device (a hood) where the smoke and steam can enter it and be conveyed away by an exhaust system. A kitchen exhaust system including an exhaust hood (210) situated over the cooking units and communicating with an exhaust assembly through an exhaust duct. Exhaust duct extends through the roof of enclosure and terminates in exhaust assembly by which to exhaust air from volume to the outside environment. Exhaust assembly may include a fan motor and associated fan as is well understood by which to expel air from assembly at a volume rate. Thus, when motor is running, an air flow path is defined between cooking units and outside environment. As air follows the air flow path, cooking heat and cooking by-products generated by the cooking units are drawn along to be exhausted to the outside environment rather than into the rest of the facility. The above description is a typical kitchen exhaust system.

Variable Speed Driver (213) should be installed on the exhaust fan motor (211). Temperature sensors (221) and VOC sensors (222) should be installed on the exhaust air duct for each hood. Facility may install airflow measurement means (223) such as Fan airflow station to achieve the kitchen area pressurization control. As will be explained in more detail below, a control system (controller 220) controls the VSD speed (213) of the exhaust fan motor (211) according to a current operating temperature and the current VOC gas concentration. The illustrated sensors (221 and 222) are exemplary in nature and other types of sensors as well as their respective locations are contemplated.

Facility may advantageously include a make-up air system (212) represented diagrammatically to bring air from the outside environment to the ambient air environment within kitchen to compensate for the volume of air exhausted by the exhaust system. Variable Speed Driver (214) should be also installed on the make-up unit supply fan motor (214) if make-up unit is installed. Facility may install airflow measurement means (224) such as Fan airflow station to measure the total make-up airflow rate. Facility may also install airflow measurement means (223) such as Fan airflow station to measure the total exhaust airflow rate. The airflow measurement means (223, 224) should be able to communicate with the kitchen exhaust fan control system. As will be explained in more detail below, the control system (controller 220) controls the VSD speed (214) of the make-up unit supply fan motor (212) speed to maintain the airflow difference between the supply and exhaust airflow.

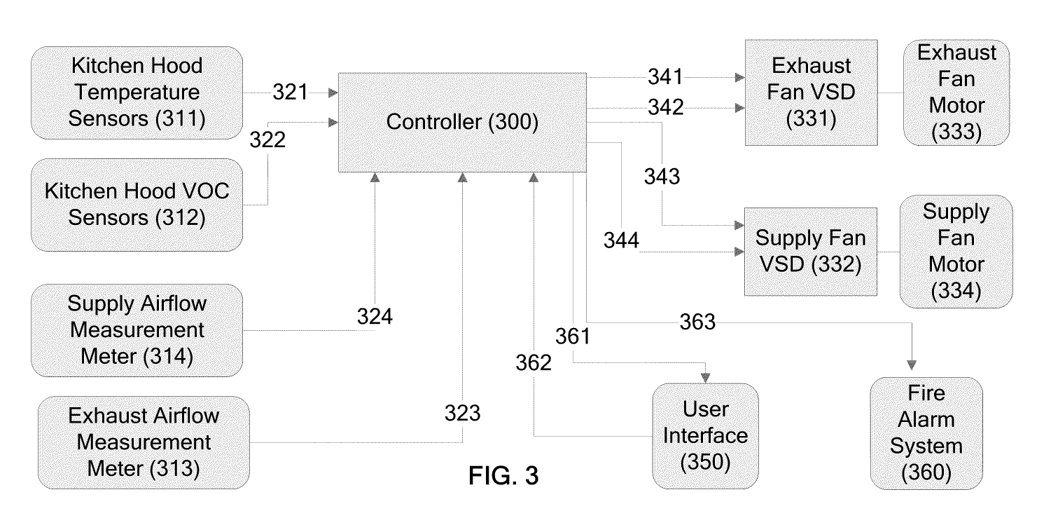

FIG. 3 depicts sensors connections and that monitor one or more environmental parameters in the kitchen. It can be seen that control system should include a microprocessor-based component or controller (300) which receives the signals from the various sensors (311, 312, 313 and 314) over cables 321, 322, 323 and 324 and generates signals to the VSD (331 and 332) over cables 341 and 343 to achieve the above-described functions. To this end, a motor speed controller (300) is provided by which to vary the speed of VSD (331) and thus its associated exhaust fan motor (333) so as to vary the volume rate of air exhausted through exhaust assembly.

The controller may turn on and off the VFD of exhaust fan and supply fan through cable 342 and 344. The controller may also link to a user interface for use by kitchen personnel using cable 361 and 362. The controller (300) may send the signal to the fair alarm system (360) through the cable 363 if the exhaust duct temperature is higher than the certain degree.

Control Algorithms

The above description of an exemplary exhaust hood control system is provided to lay the foundation for discussing the aspects and features of embodiments of the present invention.

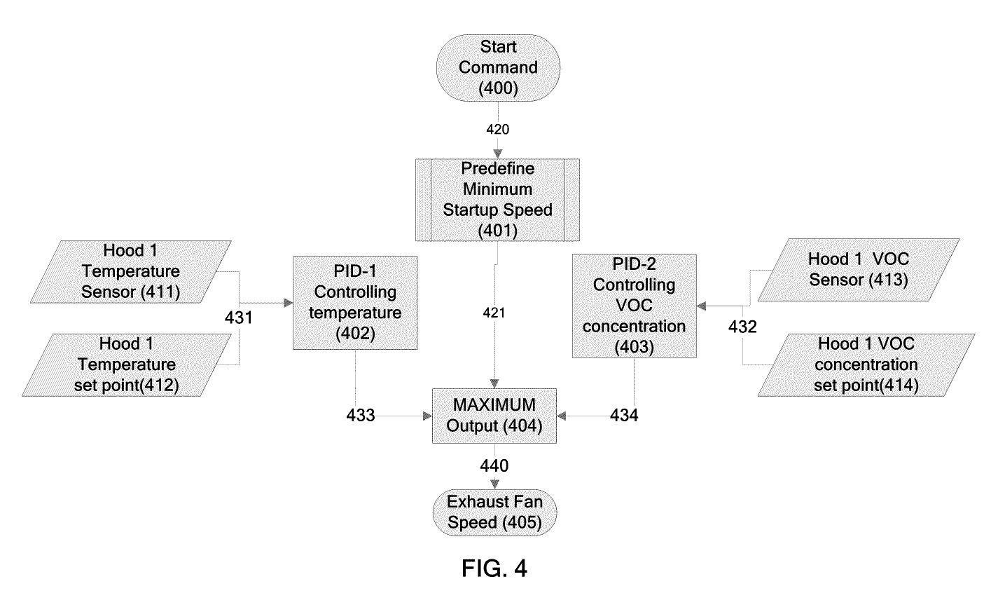

FIG. 4 depicts a more detailed control flow diagram of the exhaust fan speed. This diagram uses one fan with one hood control as an example. When the exhaust fan is started up (400), the VSD speed is started from the pre-determined minimum VSD speed (401). As cooking takes place, the VOC concentration and exhaust temperature within the hood will likely increase. These increases are detected by the VOC sensors and temperature sensors. The exhaust temperature and VOC concentration are the control variables which are controlled by the proportional-integral-derivative control (PID) loop. One PID loop (402) is controlled to maintain the hood temperature(411) at set point (412). Another PID (403) control loop is controlled to maintain the hood smoke (VOC) concentration (413) at the set point (414). The exhaust fan VSD speed is the higher value of those two PID loops and the predefined minimum speed (401). If there is more than one hood for this exhaust fan, the maximum hood temperature or the highest VOC concentration will be used in the PID loops.

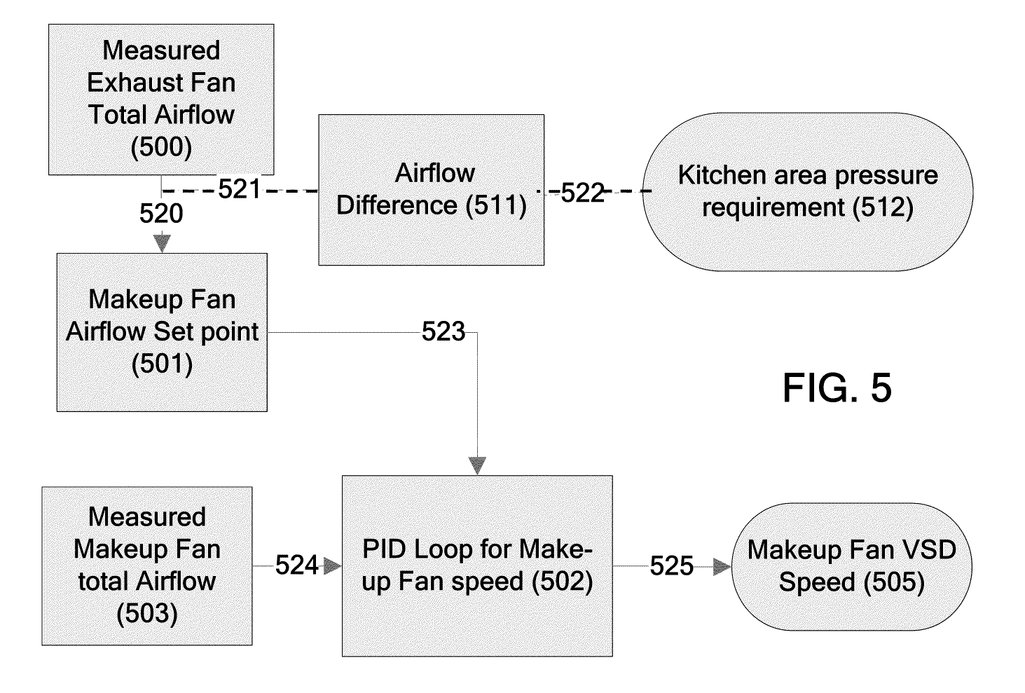

FIG. 5 depicts a more detailed control flow diagram of the makeup unit supply fan speed. The purpose of supply fan control is to maintain the required pressure (512) between kitchen area and dining area. The building pressurization control methods have been developed over the last 30 years. These methods are fan tracking, direct building pressure control, and volumetric tracking. Volumetric tracking is the only way to maintain required pressure control at all time. Both supply and exhaust airflow rate may be measured and monitored during the control process using an airflow measurement means such as fan airflow station (more detail described in patent application Ser. No. 11/491,767). The make-up unit supply fan VSD speed is controlled to maintain the supply air flow set point (501). The supply air flow set point (501) is reset to keep the constant difference (511) between the measured exhaust air flow (500) and make-up airflow (503).

It will be apparent to those having skill in the art that various changes may be made to the details of the above described embodiment of this invention without departing from the underlying principles thereof. The scope of the present invention should, be determined only by the following claims.

What is claimed is:

1. A method of varying the kitchen hood exhaust air and make-up using the following system: the control system comprising a control device for controlling the variable frequency drive (VSD) for both exhaust fan and makeup air-handling unit fan, and measurement devices comprising airflow measurement devices (for example, Fan Airflow Station), Volatile Organic Compound (VOC) gas transmitter devices and temperature transmitters devices. The exhaust fan speed is controlled to maintain the kitchen hood area at certain comfort level (indoor air quality and thermal comfort) by monitoring the VOC concentration and exhaust duct temperature. The air quality sensors measure the concentration of multiple gases and odorous substances in the air with constant output. The kitchen exhaust and make-up unit supply airflow rate are measured using the Fan Airflow Station. The kitchen make-up unit fan speed is controlled to maintain the constant airflow difference between the exhaust air and make-up air to maintain the slightly negative pressure in the kitchen area. The control system can send a fire alarm signal to building fire alarm system when the duct temperature is higher than the limit.

2. The method according to claim 1, wherein the exhaust fan speed is modulated by the control device to maintain both the VOC gas concentration and the exhaust duct temperature within the required comfort range.

3. The method according to claim 1, wherein the airflow measurement device such as Fan Airflow station to measure the total make-up airflow and total exhaust airflow rate respectively.

4. The method according to claim 1, wherein the method of air volumetric tracking of make-up air flow rate and exhaust air flow rate. The supply fan speed is modulated by the control device to maintain the constant air flow difference between the exhaust and supply in order to maintain slightly negative pressure in the kitchen area.

5. The method according to claim 4 wherein the minimum VSD speed of the exhaust fan corresponds to a minimum airflow requirement per building code or the ASHRAE handbook (HVAC application) table A30-3.

6. The method according to claim 1, wherein the rate of exhausting the air is caused to vary by increasing an operating speed of the exhaust fan from the minimum speed to the maximum speed using PID control loop (in a non-linear manner).

7. The method according to claim 1 wherein the step of identifying whether the kitchen hood is in use or not by monitoring the smoke or steam concentration and hood or duct temperature.

8. The method according to claim 7 wherein the step of monitoring the kitchen hood indoor air quality using a Indoor Air Quality (IAQ)/Volatile Organic Compound (VOC) gas transmitters. The transmitters measure the concentration of multiple gases and odorous substances in the air with constant output. These substances, for example, may be cooking smoke, kitchen vapors, human odors and unpleasant smells.
